(19) United States
(12) Patent Application Publication
(10) Pub. No.: US 2008/0292077 A1
(43) Pub. Date: Nov. 27, 2008

(54) Detection of spam/telemarketing phone campaigns with impersonated caller identities in converged networks

(75) Inventors: Dmitri Vinokurov, Ottawa (CA); Jean-Francois Rey, Brest (FR)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/802,822

(22) Filed: May 25, 2007

(51) Int. Cl. H04M 1/56

(52) U.S. Cl. 379/142.04

(57) ABSTRACT

A method of detecting a campaign of unwanted telephone calls in a converged telephone network, including populating a first set of caller identifications where no call has been initiated to the caller identification during a predetermined period of time, populating a second set of caller identifications where a call has been initiated to the caller identification during the predetermined period of time, performing a homogeneity statistical test analysis of the first set and the second set, and interpreting the statistical analysis results in order to detect the campaign of unwanted telephone calls in the converged telephone network. Some embodiments include analyzing log messages to determine a source of the most telephone call traffic, and blocking the completion of telephone calls subsequently initiated by the determined source of the most telephone call traffic.

### BACKGROUND OF THE INVENTION

1. Field of the Invention

This invention relates generally to converged communication networks.

2. Description of Related Art

The proliferation of unwanted telephone calls is significant. Many unwanted telephone calls are originated by telephone marketers or spammers. Thus, there is a need for systems and methods for detecting the presence of telephone spam and telemarketing.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for detection of spam/telemarketing phone campaigns with impersonated caller identities in converged networks, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

The companies and individuals responsible for launching telephone spam and telemarketing campaigns prefer not to expose the actual identity of the unsolicited telephone call's originator at the call placing stage. The motivation for the companies and individuals launching spam and telemarketing to conceal the actual identity of the unsolicited telephone call's originator at the call placing stage is as follows.

Recipients of telephone spam and telemarketing campaigns can employ blocking techniques to block such calls. Typically, these blocking techniques are based on the identity of the caller. Thus, if the company and individuals launching automated telephone spam or telemarketing campaigns are able to conceal the actual identity of the unsolicited call's originator at the call placing stage, then call blocking techniques that are based on the caller's identity will not function effectively against those companies and individuals.

Some methods and controls to authenticate caller ID or detect a location of a caller in an IP telephoning network are based on the call signaling routing information. Certain public switched telephone networks (PSTNs) are reasonably considered as trusted in terms of caller identification (ID) spoofing. This is true because special equipment and network access is required to place bulk impersonated calls within the PSTN.

Unfortunately, voice over Internet protocol (VoIP) networks attached to PSTN can be used as a practical means to forge a caller's identity. Further, it is easy to develop special software that automatically generates bulk phone calls with forged caller identities. In such a system, calls can then be routed through the PSTN and reach the subscribers in the PSTN or in another VoIP network attached to the PSTN, including a large enterprise VoIP or another VoIP service provider.

Additionally, some IP private branch exchanges (PBXs) or specifically designed applications can be used for generating calls with the caller's number that is either randomized, absent, or consistently spoofing someone else's identity.

Based on the foregoing, it can be difficult to detect spam calls in a converged next generation network (NGN) based on a call originator's location, or to detect a spammer's identity by monitoring the originator's location or identity. Thus, various exemplary embodiments include independent mechanisms that detect call signaling spam behavior in a converged network. In some instances, this mechanism is based on the analysis of VoIP signaling protocol messages for call set-ups and terminations.

Although mandated in the United States, telemarketers do not always comply with the requirement that they present their true telephone number to a recipient of a telemarketing call. Most voice spam detection systems assume that a spammer consistently uses the same identity or consistently uses a known location for a reasonable period of time. Thus, many systems require one of these two factors to be true in order to detect the presence of spam or telemarketing.

Other systems imply that an identity authentication infrastructure is in place. Examples of such an infrastructure include black lists, legal actions such as the do not call registry, or proposals on systems where payments are made per communication or message transaction. Other examples include statistics or counters for each identity that do not require source authentication.

Examples of systems that also require reliable source identification include white lists, circles of trust, and enforcement of a requirement of caller identification. Such systems are alternatives wherein telephone calls from untrusted, anonymous and unknown sources are rejected.

Other systems require the calling party to enter a designated override digit in order to complete a call when a caller identification is not delivered to the called party in connection with the telephone call. Still other approaches intended to limit or reduce the proliferation of spam involve the use of disposable or limited use aliases for untrusted contacts. In such systems, a subscriber must register and use another alias after an earlier alias is compromised by one or more spammers.

Still other systems categorize all telephone callers and apply control policies specific to a variety of categories of callers. Systems such as this presume that the calling party category can be identified and that telemarketers will be legally required or otherwise police themselves to identify their directory number voluntarily.

Unfortunately, telephone call spam detection solutions that assume a spammer's identity is consistent do not work where a spammer or telemarketer randomizes or forges it identity. Likewise such systems do not work when a spammer or telemarketer does not keep the same forged identity for at least a few calls. An example of an identity includes URI or E.164 compliant telephone numbers.

In VoIP applications, it is technically feasible to randomize the caller ID so that the caller ID is different for ever single call made. Such randomization renders ineffective systems designed to detect the presence of spam telemarketing based on monitoring certain identity or source information. This is true because such detected behavior becomes void every time the forged identity is changed.

Additionally, systems designed to reject calls from unknown sources have a very limited benefit. This is true because such systems prevent establishing new contacts and prevent receiving emergency calls made from unexpected locations by trusted persons. Systems that implement disposable aliases are undesirable in many applications because extensive subscriber involvement is needed to manage the aliases, and such systems merely help to avoid spam. They do not detect or stop spam that is already reaching the subscriber.

In a converged next generation network (NGN), different kinds of communications networks are merged or converged together into a single communication network. Thus, many next generation networks include different interfaces enabling the network to operate with both legacy networks and newly developed communication networks.

In a converged NGN, the call signaling delivered to the IP domain through or from external SS7/ISDN networks is legitimately originated by the gateway, and its location, and sometimes its identity as in the case of anonymous calls is presented to the VoIP call recipient. However, endpoints from the external PSTN are not registered in the gateway. Therefore, the call spam detection modules deployed in the IP domain must rely on the caller identification information only. This information is not trusted and can be randomized.

### BRIEF DESCRIPTION OF THE DRAWINGS

In order to better understand various exemplary embodiments, reference is made to the accompanying drawings, wherein:

FIG. 1 is a schematic diagram showing a first exemplary embodiment of a converged communication network;

FIG. 2 is a schematic diagram showing a second exemplary embodiment of a converged communication network; and

FIG. 3 is a schematic diagram showing exemplary sampling domains for use in a converged communications network.

### DETAILED DESCRIPTION OF THE PREFERRED EMBODIMENTS OF THE INVENTION

The subject matter described herein pertains to situations where the location or signaling routing data cannot be relied upon to identify a call spam source. For example, the subject matter herein relates to pure SIP networks. This includes a spam detection algorithm. The spam detection algorithm described herein is tailored to pertain specifically to converged communication networks.

Certain embodiments of the algorithm separate spam detection statistics into two specific groups. The first group of spam detection statistics relates to calls from caller IDs that have not received any calls from other caller IDs within a pre-determined period. The second group of spam detection statistics used by the algorithm pertains to calls from caller IDs that have received calls from other caller IDs within the pre-determined period.

Certain embodiments also tabulate and evaluate the number of call terminations made by each caller ID in each group. The assumptions made to implement the algorithm include the assumptions that typically, spam telephone calls would be consistently terminated either by the originator or by the recipient and that the caller ID of the originator (i.e., the call party with this particular caller ID) would not receive any calls.

Initially, a new caller ID would be placed in the group of caller IDs that have not received calls from other caller IDs within a pre-determined period. Once that caller ID receives a call, the data associated with that caller ID is moved to the second group, the group pertaining the caller IDs that have received calls from other caller IDs within the pre-determined period. When the number of calls for a given caller ID in the first group reaches a threshold sufficient for “individual” statistical analysis, the data associated with that caller ID is further analyzed on the rationale that the caller ID and associated data are potentially related to spam calling.

In other words, a significant advantage of the subject matter described herein is the detection of unsolicited call behavior in instances where the presence of such unsolicited call behavior cannot be detected by any known system or method. For example, the subject matter described herein is able to identify the presence of unsolicited telephone call behavior even when the spammer's identity is forged, spoofed, or randomized, even when the spammer's location is masqueraded behind a legitimate network entity, and even when the telephone call spam is distributed by computers infected with malicious software (“malware”).

Referring now to the drawings, in which like numerals refer to like components or steps, there are disclosed broad aspects of various exemplary embodiments.

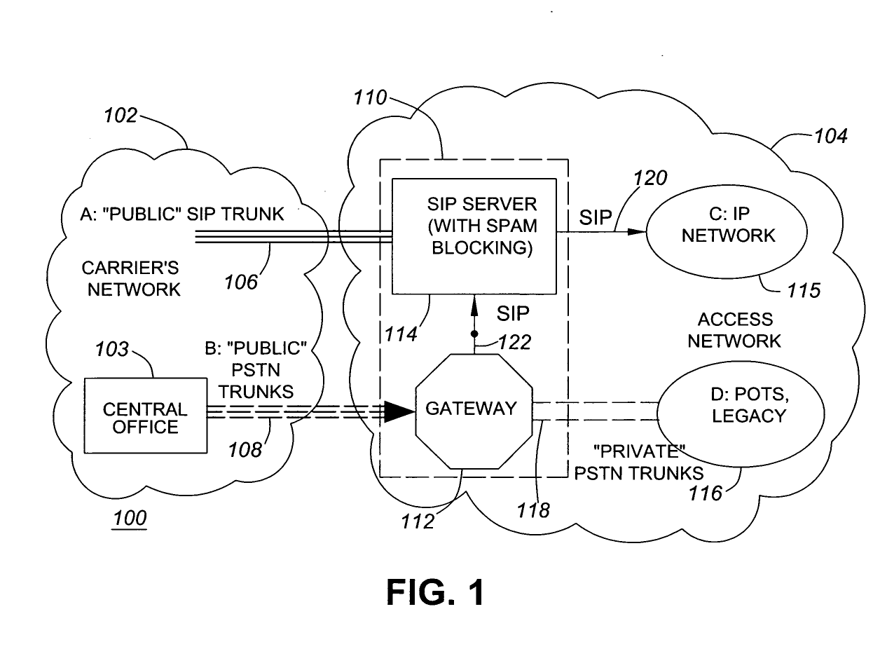

FIG. 1 is a schematic diagram showing a first exemplary embodiment of a converged communication network 100. The network 100 includes a carrier's network 102 and an access network 104. The carrier's network 102 includes a public SIP trunk 106 and a public PSTN trunk 108. A convergence platform 110 is included in the access network 104. The convergence platform 110 includes a gateway 112 and an SIP server 114. As shown, the SIP server 114 includes spam blocking.

The public SIP trunk 106 connects the carrier's network 102 with the SIP server 114. The public PSTN trunk 108 connects a central office 103 in the carrier's network 102 with the gateway 112.

The access network 104 further includes an IP network 115 and a legacy network 116. Private PSTN trunks 118 travel from the gateway 112 to the legacy network 116. An SIP 120 proceeds from the SIP server 114 to the IP network 115. Similarly, an SIP 122 proceeds from the gateway 112 to the SIP server 114. SIP 120 may have a randomized or absent caller ID.

A converged communication network 100 depicts the setup and problem definition for the converged communication networks in general. The convergence platform 110 may or may not physically combine gateway 112 and a VoIP call server.

Four outer signaling interfaces are present in FIG. 1. Those interfaces are the public and private trunks on the VoIP call server and the public and private trunks on SS7 signaling. The signaling gateway performs as a VoIP endpoint towards the VoIP server.

Thus, the subject matter shown in exemplary converged communication network 100 illustrates the problem in the case where PSTN and VoIP networks both work through the convergence platform 110 and SIP is taken as an example of signaling in the IP domain. The VoIP network may have a call spam blocking solution deployed. Since the VoIP caller's identity is not reliable information, this solution is assumed to be based on the caller's location information (e.g., SIP routing fields). That works well for calls traveling from one end to the other end in the SIP network only. However, for the VoIP network, the call signaling messages coming in from PSTN are converted to the VoIP standard by the signaling gateway.

Both spam blocking solutions deployed at the SIP server and the gateway may be unaware of the source of origin of the PSTN call. In other words, it will not be clear on the SIP server whether the original PSTN call is coming from the public trunk or the private trunk.

Further, the call might even be generated by the same source. Still, every incoming call may use a different trunk or circuit and have a different circuit code (CIC) and a different originating point code (OPC). Further, CIC and OPC do not get transformed into SIP header fields. Therefore, the only distinctive information available for analysis at the SIP server is the SIP “From” header field of INVITE messages.

In the IP domain, the call can be successfully authenticated as legimately originated at the gateway 112. Identity based statistics for call spam detection in the IP signaling domain are also inadequate when the forged caller ID is inconsistent. For example, such statistics are inadequate when the same identity is not used for more than a few calls within the observed period of time.

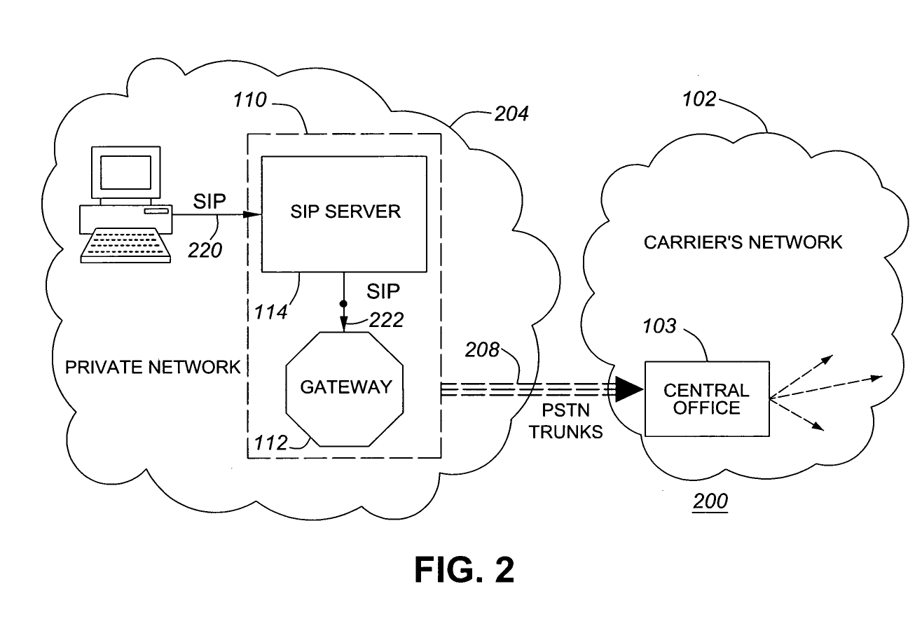

FIG. 2 is a schematic diagram showing a second exemplary embodiment of a converged communication network 200. The converged communication network 200 depicts the system that throws in telephone calls with arbitrary caller IDs into PSTN. Specifically, the converged communication network 200 includes a private network 204, PSTN trunks 208 that travel from the converged network 110 to a central office 103 in the carrier's network 102, SIP 220 received by the SIP server 114 and SIP 222, which has a randomized or absent caller ID, traveling from the SIP server 114 to the gateway 112.

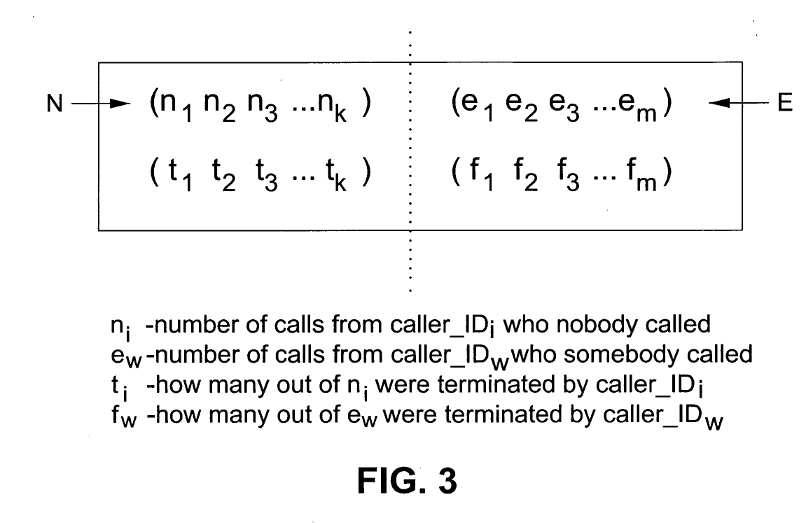

FIG. 3 is a schematic diagram showing exemplary sampling domains for use in a converged communications network. FIG. 3 includes a left sampling domain N and a right sampling domain E. Statistics calculated on the left sampling domain N and the right sampling domain E include an analysis of discrepancies between the left sampling domain N and the right sampling domain E. Such statistics are used for the detection of call spam indications. This is described in great detail below.

This approach can use the advantage of deployment on a platform that combines call server and signaling gateways. This facilitates a more efficient and automated tracking of the presence of actual spam sources in the PSTN.

The data indicated in the N and E groups is evaluated according to the following assumptions. First, it is believed that a spammer initiates calls to the targeted network, but almost nobody calls the spammer. Further, it is believed that spam calls exhibit a gross inconsistency between the frequency with which they are terminated by the spam recipient and terminated by the spam originator.

For example, when the spam call is a pre-recordered message, the calls are consistently terminated by the spam recipient. Conversely, when the spam is a voice mail deposit, the calls are consistently terminated by the spam originator. Similarly, calls are consistently terminated by either a telemarketer recipient or a telemarketer originator depending on whether the telemarketer's business model classifies them as a persistent telemarketer or a time-conscious telemarketer.

Even where statistics based on per external entity cannot be built, the presence or absence of unwanted spam or telemarketing can be evaluated and identified based on the criteria described above. Thus, the presence of spam calls coming in with a variety of caller IDs can still be identified based on the imbalance in the data described above.

In various embodiments, spam detection under the conditions described above is performed by building a statistical analysis criterion according to two groups of call sources. The two groups correspond to the N group which includes caller IDs that nobody has called within the observed time period. In other words, the N group consists of callers that have not proved a relationship with other subscribers.

The second group is the E group. The E group consists of caller IDs where at least one subscriber has successfully established a call to the caller ID within an observed time period.

In other words, group N is a group consisting of entities that do not have a reputation. Similarly, group E is a grouping of entities that have a reputation.

It should be apparent that it is technically uncomplicated to populate the N group and the E group based on an analysis of data available in a converged communications network. For example, the N and E groups can be formed on the convergence platform based on VoIP call setup and call termination messages observed on the call server.

It is not necessary for the detection module to distinguish between the flow direction of a call. For example, the caller ID may belong to any of four clusters, a public SIP, a public PSTN, a private SIP or a private legacy trunk.

The call setup messages may travel in any of eight directions between the public SIP, a public PSTN, a private SIP and a private legacy trunk, except as follows. Flow of calls between a public SIP and a public PSTN are beyond the IP part of the convergence platform. Similarly, flows between a public PSTN and private legacy trunks are beyond the IP part of the convergence platform. When the convergence platform or detection module is able to distinguish between flow directions, then only caller IDs from public domains need to be considered for analysis.

For each party ID and an array position I and groups N and E in FIG. 3, a count is performed of the number of times that calls occur in which a given caller ID participated where the call was terminated by the caller. For the purposes of this count, it does not matter whether the caller ID in question participated in the call as an originator of the call.

Only those call termination messages (SIP BYE messages) that are part of an established dialogue should matter. Otherwise there is a risk of samples {tⱼ} and {fₛ} being poisoned by a spammer or by malware maliciously installed within the private IP network.

When the caller establishes the call, and its ID is not yet listed either in the “N” or in the “E” group, certain embodiments create the new entries nₖ₊₁=1 and tₖ₊₁=0. When another INVITE or BYE message issued by this caller ID is subsequently observed, nₖ₊₁ is incremented for INVITE, or tₖ₊₁ is incremented for BYE, accordingly.

As soon as the detection module detects that a call towards the caller ID (which is already listed in the “N” group) has been successfully established, the corresponding values nᵢ and tᵢ move to the “E” group and turn into new eₘ₊₁ and fₘ₊₁. These values remain updated in that location. When nᵢ reaches the limit L sufficient for the building of individual “per caller ID” statistics, the (nᵢ, tᵢ) column may be removed and forwarded to the individual analysis.

In certain embodiments, the practical limit of L is set at 20 telephone calls. In other embodiments, the practical limit of L is higher or lower than 20 telephone calls, depending on local conditions.

The situation where telephone calls are made anonymously constitutes a special case. An incoming call is anonymous if the original SIP “From” header was either blank or unusable. This results in empty CIN parameters in SS7 messages. When regulations are being followed, the recipient's gateway fills in the “From” header either by the host name of the gateway or some other pre-determined information according to a local policy. Alternatively, if the “presentation restricted” ISUP indicator is set, the value of the “From” header may be listed as anonymous or something similar which is consistent over time.

The implication of the foregoing situation where calls are made anonymously is two-fold. First, anonymous calls always stay and contribute to the N group in the data set depicted in FIG. 3. This is true because no calls are made to an anonymous recipient. Second, if anonymous spam calls are made on the background of legitimate anonymous calls, the corresponding Nᵢ would soon exceed the limit L in the corresponding pair (nᵢ, tᵢ) and would be moved to the individual “per identity” analysis where spam behavior can be detected. An example of legitimate anonymous calls is business to business calls that are often made anonymously.

Further analysis of the ({nᵢ},{tⱼ}) and ({eᵣ},{fₛ}) sets leads to call spam indication. The basic assumption is that a call spam campaign is associated with a statistical imbalance of directions of both call setup and termination requests of call dialogs in which the spammer participates. Thus, various embodiments include one or both of two indicators as follows.

The first indicator of the presence of spam or a telemarketing campaign is a significant deviation of SUM{tᵢ} from its assumed average SUM{nᵢ}/2. The probability P of the observed deviation can be estimated, for instance, using quantiles of the Standard Normal Distribution N(0,1). The value of (2*SUM{tᵢ}−SUM{nᵢ})/(SUM{nᵢ})^{1/2} can be approximated by N(0,1), providing the total number of calls is sufficient to allow so, i.e. SUM{nᵢ}>L. The reliability of this method is 1−P.

The second indicator of the presence of spam or telemarketing calls is a significant difference in distribution of ({nᵢ},{tⱼ}) and ({eᵣ},{fₛ}).

Where the two samples are heterogeneous, this is believed to indicate relatively consistently different call termination behaviors in the dialogues with those who were never called within the observed time window as opposed to those who received calls during the observed time window. The difference in the distribution between ({nᵢ},{tⱼ}) and ({eᵣ},{fₛ}) can be estimated using known statistical hypothesis tests that test the hypothesis that the distributions of sets ({nᵢ},{tⱼ}) and ({eᵣ},{fₛ}) are homogenous. Examples of known statistical hypothesis tests for homogeneity include the Student's T-test and the Kolmogorov-Smimov test.

The ability to react to the detective presence of spam can include tracing back to a spam source upon identification of the presence of spam and behavior. For example, logs on the gateway could be used to detect the CIC or OPC that contributed most to the N group depicted in FIG. 3 at the moment when spam was detected.

Administrators or other means can be employed to check log messages after a “presence of spam” alarm is triggered by the statistical analysis engine. This analysis would reveal the source of the most traffic. That source is likely to be a source of unwanted traffic such as spam or telemarketing.

According to the foregoing, a system in method is described to identify unwanted and unsolicited telephone calls such as spam and telemarketing in converged NGN networks. The system and method described herein is applicable to implementation on both enterprise gateways and access signaling gateways. One or more of the following advantages may be realized by various embodiments of the subject matter described herein.

Spam may arrive from traditional as well as from IP telephone networks. Trusted caller identification or caller location information is not required. Only local targeted network policy and capabilities need be relied upon.

Only signaling messages are analyzed, not actual media flows. Collaboration of end-users or upgrade of terminal devices is not required.

Unsolicited call behavior can be detected in challenging cases where a spammer's identity is forged, spoofed or randomized or a spammer's location is masqueraded behind a legitimate network entity. Likewise, unsolicited call behavior can be identified in challenging cases where spam is sent in a distributed manner by computers infected with malware.

Thus, the ability to mitigate the impact of unwanted telephone calls such as spam activity to the consumers of telephone services is a tremendous value available to providers of network media services. Accordingly, one of the top security issues, particularly efficient spam mitigation, can be identified. Such mechanisms may be a value-adding differentiator in the NGN equipment market. Thus, suppliers who provide features in their products incorporating the subject matter described herein may be at a market advantage over those who do not.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method of detecting a campaign of unwanted telephone calls in a converged telephone network, comprising:
establishing a period of time for observation of data;
populating a first set of caller identifications where no call has been initiated to the caller identification during the established period of time;
moving caller identifications from the first set to a second set of caller identifications when a call is initiated to the caller identification during the established period of time;
interpreting a homogeneity statistical test analysis of the first set and the second set in order to detect the campaign of unwanted telephone calls in the converged telephone network.

2. The method of detecting a campaign of unwanted telephone calls in a converged telephone network, according to claim 1, wherein interpreting the homogeneity statistical test analysis of the first set and the second set comprises an evaluation of a statistical homogeneity between the first set and the second set.

3. The method of detecting a campaign of unwanted telephone calls in a converged telephone network, according to claim 2, wherein the homogeneity statistical test is a statistical hypothesis test that tests a hypothesis that the first set and the second set are homogenous.

4. The method of detecting a campaign of unwanted telephone calls in a converged telephone network, according to claim 2, wherein the homogeneity statistical test is a Kolmogorov-Smirnov test.

5. The method of detecting a campaign of unwanted telephone calls in a converged telephone network, according to claim 1, wherein the campaign of unwanted telephone calls is spam.

6. The method of detecting a campaign of unwanted telephone calls in a converged telephone network, according to claim 1, wherein the campaign of unwanted telephone calls is a telephone marketing campaign.

7. A method of detecting a campaign of unwanted telephone calls in a converged telephone network, comprising:
populating a first set of caller identifications where no call has been initiated to the caller identification during a predetermined period of time;
populating a second set of caller identifications where a call has been initiated to the caller identification during the predetermined period of time; and
interpreting a homogeneity statistical test analysis of the first set and the second set in order to detect the campaign of unwanted telephone calls in the converged telephone network.

8. The method of detecting a campaign of unwanted telephone calls in a converged telephone network, according to claim 7, wherein the first set and the second set are populated based on VoIP call setup messages observed on a call server.

9. The method of detecting a campaign of unwanted telephone calls in a converged telephone network, according to claim 7, further comprising counting a number of times each caller identification participates in a telephone call and counting a number, the number being selected from the list consisting of a number of times the telephone call was terminated by a called party, and a number of times the telephone call was terminated by a calling party.

10. The method of detecting a campaign of unwanted telephone calls in a converged telephone network, according to claim 9, wherein only BYE messages that are part of an established dialog are considered.

11. A method of eliminating a campaign of unwanted telephone calls in a converged telephone network, comprising:
populating a first set of caller identifications where no call has been initiated to the caller identification during a predetermined period of time;
populating a second set of caller identifications where a call has been initiated to the caller identification during the predetermined period of time;
performing a statistical analysis of the first set and the second set;
interpreting the statistical analysis of the first and the second set in order to detect the campaign of unwanted telephone calls in the converged telephone network;
analyzing log messages to determine a source of the most telephone call traffic; and
blocking the completion of telephone calls subsequently initiated by the determined source of the most telephone call traffic.

12. The method of eliminating a campaign of unwanted telephone calls in a converged telephone network, according to claim 11, further comprising triggering an alarm indicating the presence of the campaign of unwanted telephone calls.

13. The method of eliminating a campaign of unwanted telephone calls in a converged telephone network, according to claim 11, wherein the converged telephone network is a next generation network.

14. The method of eliminating a campaign of unwanted telephone calls in a converged telephone network, according to claim 11, wherein the method is implemented in an enterprise gateway.

15. The method of eliminating a campaign of unwanted telephone calls in a converged telephone network, according to claim 11, wherein the method is implemented in an access signaling gateway.
